(19) United States
(12) Patent Application Publication
(10) Pub. No.: US 2007/0021906 A1
(43) Pub. Date: Jan. 25, 2007

(54) ROAD INFORMATION SYSTEM AND METHOD FOR PROVIDING ROAD INFORMATION BASED ON INTERNET PROTOCOL

(75) Inventors: Chun-Nan Yeh, Puli Township, Nantou County (TW); Jien-Yang Chang, Kuei San Hsiang, Taoyuan (TW)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: MITAC INTERNATIONAL CORP., Kuei San Hsiang (TW)

(21) Appl. No.: 11/459,177

(22) Filed: Jul. 21, 2006

(30) Foreign Application Priority Data
Jul. 22, 2005 (TW) 094124974

(51) Int. Cl. G01C 21/00

(52) U.S. Cl. 701/207; 701/208; 340/995.1

(57) ABSTRACT

A road information system and a method for providing road information based on Internet protocol are provided, wherein typically, a client sends out a connection signal, so as to establish a connection with a road information server, then, according to the current position coordinates, the client downloads corresponding road information from the road information server, so as to obtain the road information in the road information server immediately.

### CROSS-REFERENCE TO RELATED APPLICATIONS

This non-provisional application claims priority under 35 U.S.C. §119(a) on Patent Application No(s). 094124974 filed in Taiwan, R.O.C. on Jul. 22, 2005 the entire contents of which are hereby incorporated by reference.

### BACKGROUND OF THE INVENTION

1. Field of Invention

The present invention relates to a road information system and a method for providing road information, and more particularly to a road information system and a method for providing road information based on the Internet protocol.

2. Related Art

Nowadays, due to high convenience and demand, wireless communication becomes very popular. The release of the Global Positioning System (GPS) in particular promotes the development of another series of products. At present, the most obvious application of the navigation system in the civilian use is a vehicle navigation device, which allows a driver to know his/her position, and then directs the driver to arrive the destination.

However, with the development of the transportation industry, the problem of traffic jams becomes more and more severe; thus, people need to know the road information in real time, so as to avoid traffic jams. Therefore, since 2001, a commercialized service of Traffic Management Center (TMC) has been introduced in Europe. TMC has in total 18 state members, and 60% of the construction expense is subsidized by governments, and the rest is sponsored by enterprises. The TMC system promotes compatibility. The 18 state members share traffic information, and together develop a TMC system with digital broadcasting functionality.

The TMC system comprises real-time information of the real-time road conditions, such as traffic flow, traffic accident locations, and the affected traffic lanes, traveling speed, and car models. The road information is sorted by a road administration center and then updated every 2 or 3 minutes, so as to be transmitted to the TMC. The TMC sends the road information to radio broadcasting stations, which receive the road information through a radio and an antenna and then provides it to the driver as a visual or voice message, so as to prevent the driver from driving to a congested road, thereby solving the problem of traffic jams.

As for the conventional method of monitoring the traffic flow, a monitoring system is disposed above the road to detect the traffic flow through a monitor and then transmits the road conditions to a monitor center. Then, the road information is sent to the broadcasting station, TV station, or the other media, so as to provide the road condition information to drivers, thereby solving the problem of traffic jams.

However, the conventional method of monitoring the traffic flow still cannot solve the problem of traffic jams, because car drivers are unable to obtain the traffic information in immediately. The road information is processed by complicated manual operations, for example, after being received, the road information is sorted manually and then transmitted to drivers via the wireless broadcasting station and TV, thus, when receiving the road information, the time of the event is overdue.

Furthermore, since the wireless broadcasting station informs drivers of real-time traffic information via broadcast or rebroadcast by a TV station during a specific time period, if drivers miss the chance to listen, the drivers cannot obtain road information for that time.

### SUMMARY OF THE INVENTION

It is an object of the present invention to provide a road information system and a method for providing road information based on the Internet protocol, so as to solve the problems that drivers may not be able to obtain road information in real-time.

In order to achieve the object, the present invention provides a road information system and a method for providing road information based on the Internet protocol. A client establishes a connection with a road information server through an Internet website address corresponding to the road information server and obtains the road information stored in the road information server. Firstly, the client obtains current position coordinates through a positioning module, and transmits a connection signal with the Internet website address of the road information server, so as to establish the connection with the road information server. After that, a signal processing module processes the signal transmitted between the client and the road information server to obtain a signal for downloading and updating data. Finally, according to the signal for downloading and updating data, an update module downloads the road information corresponding to the current coordinates of the client from the road information server, such that the client obtains the road information in the road information server.

In order to achieve the object, the present invention further discloses a method for providing road information based on the Internet protocol, which is first to send a connection signal with the Internet website address of the road information server from the client. Next, a feedback connection signal is received from the road information server, such that the connection is established between the client and the road information server. Then, a signal for downloading and updating data is sent to the road information server, so as to obtain the current position coordinates of the client. Then, the road information corresponding to the current coordinates is downloaded from the road information server to the client according to the signal for downloading and updating data. And then an end signal is sent to the road information server. Finally, an acknowledged end signal is received from the road information server, thereby finishing the program of obtaining the road information.

In view of the above, the client establishes the connection with the road information server through the Internet website address of the road information server in the present invention, so as to obtain the road information in the road information server immediately.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is an architecture view of a road information system based on the Internet protocol according to the present invention;

FIG. 2 is a block diagram of the road information system based on the Internet protocol according to a first embodiment of the present invention; and

FIG. 3 is a flow chart of a method for providing road information based on the Internet protocol according to a second embodiment of the present invention.

### DETAILED DESCRIPTION OF THE INVENTION

As for the flow information system based on the Internet protocol provided by the present invention, a client 10 establishes a connection with a road information server through an Internet website address of the road information server in an Internet system, so as to obtain road information immediately.

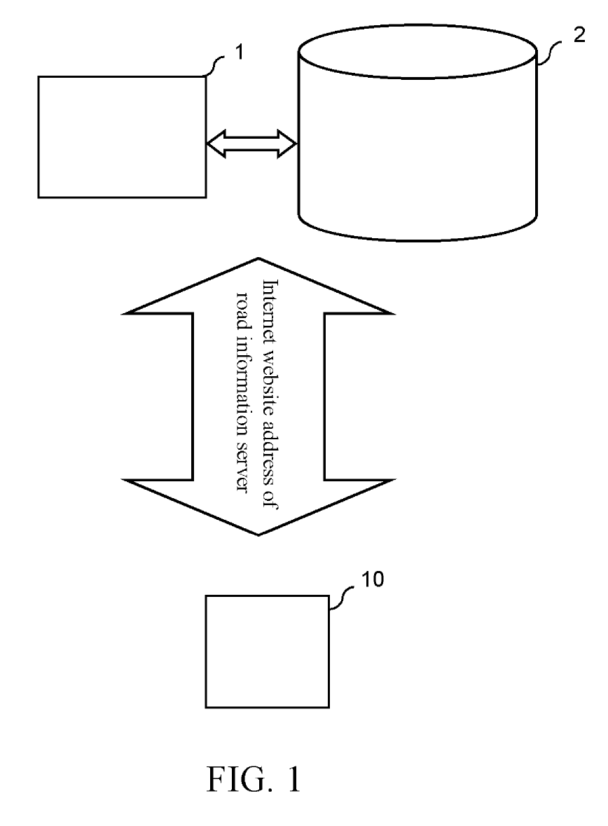

Please refer to FIG. 1 of an architecture view of a road information system based on the Internet protocol according to the present invention. The client 10 establishes a connection with the road information server 1 through the Internet website address of the road information server, so as to obtain the road information 2 stored in the road information server 1 corresponding to the current position of the client 10. The client 10 may be a mobile phone, a personal digital assistant (PDA), a notebook, or a vehicle navigation device etc.

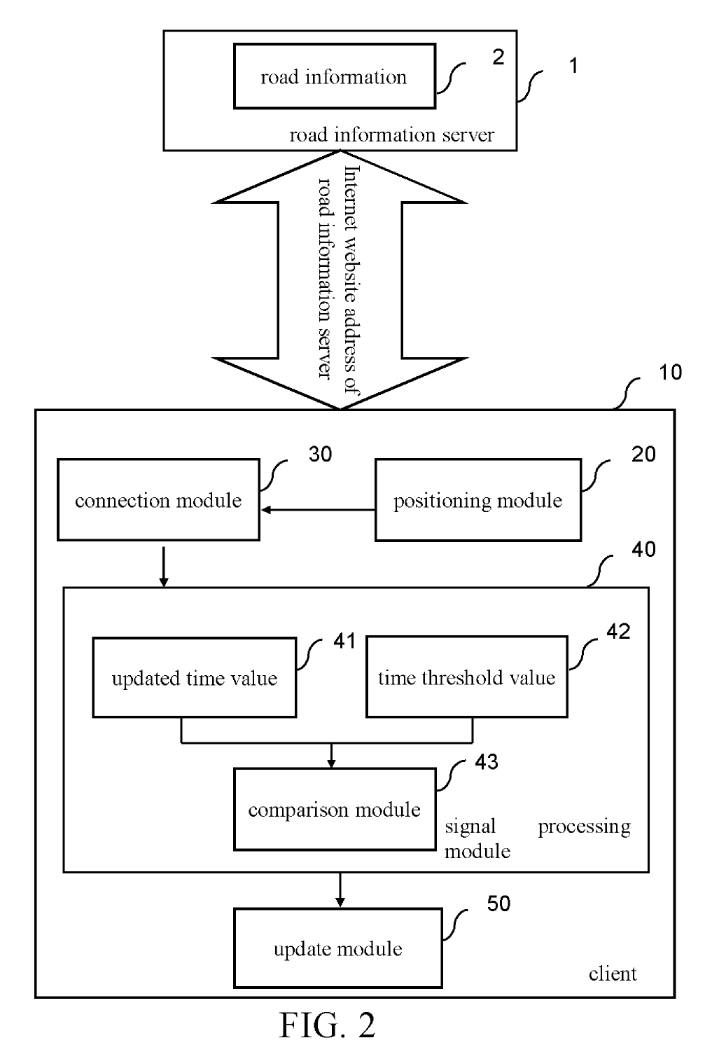

Please refer to FIG. 2 of a block diagram of the road information system based on the Internet protocol according to a first embodiment of the present invention. As for the road information system, for example, the client 10 establishes a connection with the road information server 1 through the Internet website address of the road information server 1, so as to obtain the road information 2 stored in the road information server 1 corresponding to the current position of the client 10. The road information system at least comprises an Internet system used for establishing a connection between the client 10 and the road information server 1, and a display used for displaying the road information 2.

The road information server 1 stores the road information 2 and the Internet website address. The client 10 comprises a positioning module 20, a connection module 30, a signal processing module 40, and an update module 50. Furthermore, the signal processing module 40 stores an updated time value 41 and a time threshold value 42 and comprises a comparison module 43. The detailed operations and connecting block diagrams will be described blow.

The client 10 and the road information server 1 are under a status of the Internet system. The client 10 establishes a connection with the road information server 1 through the Internet website address of the road information server 1. Firstly, the client 10 obtains the current position coordinates by using the positioning module 20, such as a global positioning receiver, and then transmits a connection signal with the Internet website of the road information server 1 through the connection module 30, so as to establish the connection with the road information server 1. The client 10 establishes the connection with the road information server 1 through a wireless network chip. The connection signal contains an authorized data and current position coordinates data.

Next, the signal processing module 40 processes the communication between the client 10 and the road information server 1 to obtain a signal for downloading and updating the data. The signal processing module 40 stores the updated time value 41 and the time threshold value 42, and further comprises the comparison module 43 for comparing the updated time value 41 with the time threshold value 42, so as to obtain the signal for downloading and updating data, wherein the updated time value is the time counted since last time of downloading road information. Additionally, the communication between the client 10 and the road information server 1 is at least one of a feedback connection signal, a signal for downloading and updating data, an end signal, and an acknowledged end signal.

Finally, according to the signal for downloading and updating data, the update module 50 downloads the road information 2 corresponding to the current position coordinates of the client 10 from the road information server 1, e.g., latest traffic information, electronic map information, weather information, tourist spot information, activity information, and emergency rescue information.

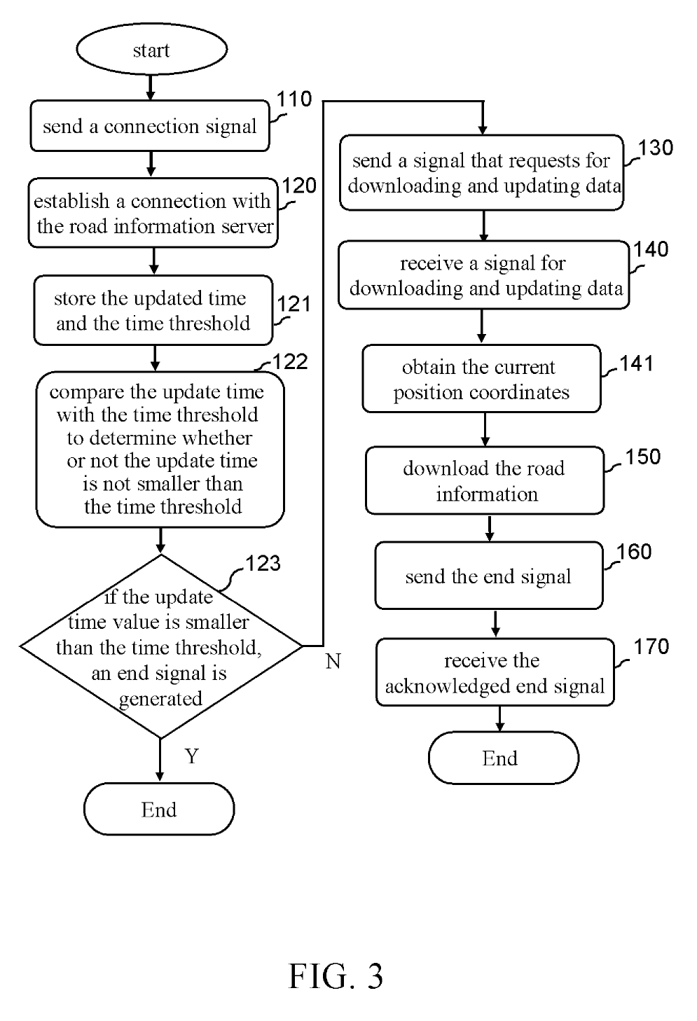

Please refer to FIG. 3 of a flow chart of a method for providing road information based on the Internet protocol according to a second embodiment of the present invention. The method of the present invention comprises the following steps. Firstly, the client sends a connection signal with the Internet website address of the road information server (Step 110), wherein the connection signal contains the authorized data and the current position coordinates data. Then, the client receives the feedback connection signal from the road information server to establish a connection with the road information server (Step 120).

After the client has established the connection with the road information server, the updated time value and the time threshold value are stored in the client (Step 121), wherein the updated time value is the time counted since last time of downloading road information. Then, the updated time value is compared with the time threshold value through the comparison module, so as to determine whether or not the updated time value is not smaller than the time threshold value (Step 122). If the updated time value is smaller than the time threshold value, the client generates an end signal (Step 123), to stop the procedure of updating the road information.

If the updated time value is not smaller than the time threshold value, the client sends the signal that requests for downloading and updating data to the road information server (Step 130). Next, the client receives the signal for downloading and updating data from the road information server (Step 140). After that, the current position coordinates of the client is obtained (Step 141) through the global positioning receiver. Then, according to the signal for downloading and updating data, the road information corresponding to the current coordinates is downloaded from the road information server to the client (Step 150), wherein the road information is at least one of latest traffic information, electronic map information, weather information, tourist spot information, activity information, and emergency rescue information.

Finally, the client sends an end signal to the road information server (Step 160) and then receives an acknowledged end signal from the road information server (Step 170), thereby finishing the procedure of obtaining the road information.

The road information system based on the Internet protocol disclosed by the present invention is mainly characterized in that, the communication mechanism between the client and the road information server is established to allow the client to obtain the road information in the road information server immediately.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A road information system based on Internet protocol, comprising:
a road information server having an Internet website address for storing a road information; and
a client, obtaining the corresponding road information according to current position coordinates, comprising:
a positioning module for obtaining the current position coordinates;
a connection module for transmitting a connection signal with the Internet website address, thereby establishing the connection with the road information server;
a signal processing module for processing communications between the client and the road information server, thereby obtaining a signal for downloading and updating data; and
an update module for downloading the road information corresponding to the current coordinates from the road information server according to the signal for downloading and updating data.

2. The road information system as claimed in claim 1, wherein the signal processing module stores an updated time value and a time threshold value, and comprises a comparison module for comparing the updated time value with the time threshold value, so as to obtain the signal for downloading and updating data.

3. The road information system as claimed in claim 2, wherein the updated time value is the time counted since last time of downloading the road information.

4. The road information system as claimed in claim 1, wherein the connection signal comprises an authorized data and a current position coordinates data.

5. The road information system as claimed in claim 1, wherein the road information is at least one of latest traffic information, electronic map information, weather information, tourist spot information, activity information, and emergency rescue information.

6. The road information system as claimed in claim 1, wherein the connection module is a wireless network chip.

7. The road information system as claimed in claim 1, wherein the communication between the client and the road information server is at least one of a feedback connection signal, a signal for downloading and updating data, an end signal, and an acknowledged end signal.

8. The road information system as claimed in claim 1, wherein the positioning module is a global positioning receiver.

9. A method for providing road information based on Internet protocol, comprising:
sending a connection signal with an Internet website address of a road information server from a client;
receiving a feedback connection signal from the road information server, such that the client establishes a connection with the road information server;
sending a signal that requests for downloading and updating data to the road information server;
receiving a signal for downloading and updating data from the road information server;
obtaining a current position coordinates of the client;
downloading road information corresponding to the current coordinates from the road information server to the client according to the signal for downloading and updating data;
sending an end signal to the road information server; and
receiving an acknowledged end signal from the road information server.

10. The method for providing road information as claimed in claim 9, wherein the step of receiving a feedback connection signal from the road information server to establish a connection between the client and the road information server comprises:
storing an updated time value and a time threshold value in the client; and
comparing the updated time value with the time threshold value to determine whether or not the updated time value is not smaller than the time threshold value.

11. The method for providing road information as claimed in claim 10, wherein the updated time value is the time counted since last time of downloading road information.

12. The method for providing road information as claimed in claim 10, after the step of comparing the updated time value with the time threshold value to determine whether or not the updated time value is not smaller than the time threshold value, further comprising a step of generating an end signal from the client when the updated time value is smaller than the time threshold value.

13. The method for providing road information as claimed in claim 9, wherein the step of obtaining the current position coordinates of the client is achieved through a global positioning receiver.

14. The method for providing road information as claimed in claim 9, wherein the connection signal comprises an authorized data and a current position coordinates data.

15. The method for providing road information as claimed in claim 9, wherein the road information is at least one of latest traffic information, electronic map information, weather information, tourist spot information, activity information, and emergency rescue information.
